(19) United States
(12) Patent Application Publication
(10) Pub. No.: US 2013/0014236 A1
(43) Pub. Date: Jan. 10, 2013

(54) METHOD FOR MANAGING IDENTITIES ACROSS MULTIPLE SITES

(75) Inventors: Nicholas D. Bingell, Raleigh, NC (US); Erich P. Hoppe, Apex, NC (US); Andrew J. Ivory, Wake Forest, NC (US); David M. Stecher, Durham, NC (US)

(73) Assignee: International Business Machines Corporation, Armonk, NY (US)

(21) Appl. No.: 13/176,573

(22) Filed: Jul. 5, 2011

(51) Int. Cl. H04L 9/32

(52) U.S. Cl. 726/6

(57) ABSTRACT

A method, data processing system, and computer program product for managing passwords. A computer system receives a notification from a website that indicates a password for the website needs to be changed. If the computer system determines the website is in a list of websites and a classification of the website matches one or more of a set of website classifications, a notification is sent to a password vault that indicates the password for the website needs to be changed. A set of passwords in the password vault is selected based upon the set of passwords meeting a policy for password management.

### BACKGROUND

1. Field

The present disclosure relates generally to managing passwords and, in particular, to a method and apparatus for managing passwords for a set of websites. Still more particularly, the present disclosure relates to a method and apparatus for updating a set of passwords for a set of websites when a password for a particular website is expired or compromised.

2. Description of the Related Art

Much of today's computer-related security is based upon the concept of the password. A wide range of services, from bank accounts to social networking, can be accessed with a password. There are many advantages to using a password, including ease of recall for users and the providing of a reasonable amount of security. A disadvantage to using a password is the inability to know when the password has become compromised. Moreover, many organizations require users to change their passwords at certain time intervals. Therefore, users often have to remember many different passwords.

A delay is often present before a user finds out that a password for a particular website expires or is compromised. Even if the user quickly discovers that the password needs to be updated, the user may have to go though several steps before the password can be updated. Thus, the process of updating a password for a website can be relatively time-consuming and arduous.

Additionally, users often use the same password for multiple websites. Therefore, if a password becomes compromised on one website, the user may be vulnerable to security breaches on other websites. Moreover, users may not remember to update passwords at regular intervals on different websites in order to provide a higher level of security against password compromise.

### SUMMARY

The different illustrative embodiments provide a method, data processing system, and computer program product for managing passwords. A computer system receives a notification from a website that indicates a user's password for the website needs to be changed. If the computer system determines the website is in a list of websites and a classification of the website matches one or more of a set of website classifications, a notification is sent to a password vault that indicates the password for the website needs to be changed. A set of passwords in the password vault is selected based upon the set of passwords meeting a policy for password management.

### BRIEF DESCRIPTION OF THE SEVERAL VIEWS OF THE DRAWINGS

FIG. 1 is an illustration of a network of data processing systems in which illustrative embodiments may be implemented;

FIG. 2 is an illustration of a data processing system in accordance with an illustrative embodiment;

FIG. 3 is an illustration of a password management environment in accordance with an illustrative embodiment;

FIG. 4 is an illustration of a password management environment in accordance with an illustrative embodiment;

FIG. 5 is an illustration of a flowchart of a process for managing passwords in accordance with an illustrative embodiment; and

FIG. 6 is an illustration of a flowchart of a process for managing passwords in accordance with an illustrative embodiment.

FIG. 7 is an illustration of a flowchart of a process for managing passwords in accordance with an illustrative embodiment.

### DETAILED DESCRIPTION

As will be appreciated by one skilled in the art, aspects of the illustrative embodiments may be embodied as a system, method or computer program product. Accordingly, aspects of the illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrative embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the illustrative embodiments may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrative embodiments are described below with reference to flowchart illustrations and/or block diagrams of methods, apparatus (systems) and computer program products according to illustrative embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which are processed on the computer or other programmable apparatus provide processes for implementing the functions/acts specified in the flowchart and/or block diagram block or blocks.

The different illustrative embodiments recognize and take into account that currently, the ability for passwords to be updated on multiple websites due to a notification of an expiring or compromised password on a particular website is not available. The different illustrative embodiments recognize and take into account that updating multiple websites due to a particular password being compromised or expiring may be desirable.

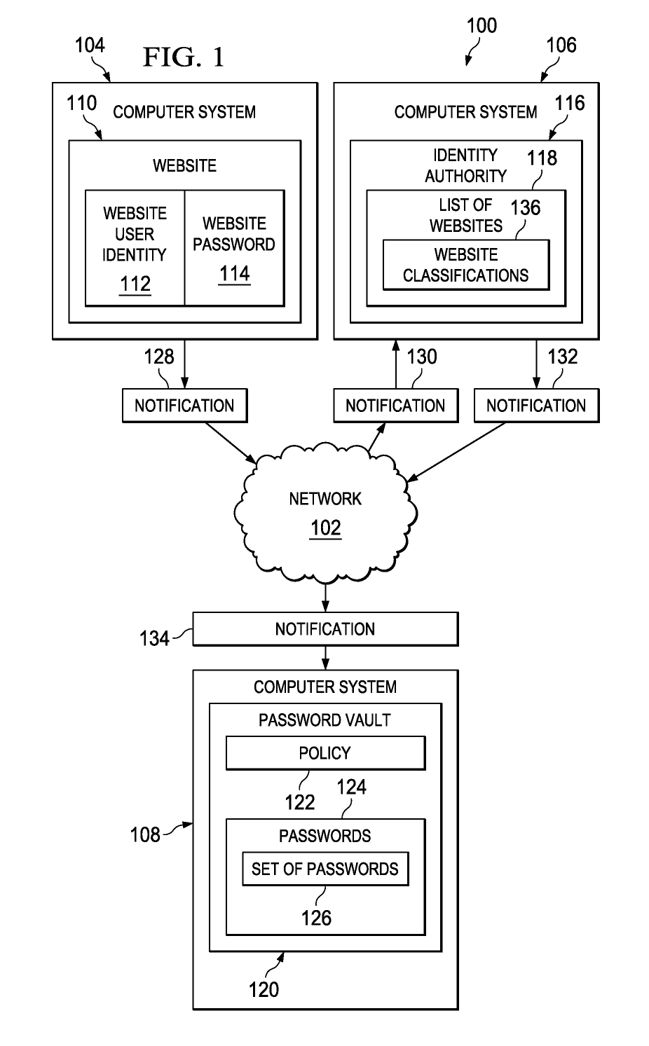

FIG. 1 depicts an illustration of a network of data processing systems in which illustrative embodiments may be implemented. Network data processing system 100 is an example of computer systems in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, computer system 104, computer system 106, and computer system 108 connect to network 102. Computer system 104, computer system 106, and computer system 108 may comprise one or more computers, server computers, client computers, personal devices, or any other systems capable of running program code.

In the depicted example, computer system 104 includes a website 110 with an associated website user identity 112 and website password 114 that corresponds to website user identity 112. Website 110 may include one or more additional pairs of website user identity 112 and corresponding website password 114. Website 110 may be a server or a combination of hardware and software capable of allowing a user to access information or services after providing website user identity 112 and website password 114. Computer system 104 may include one or more additional websites.

Furthermore, in the depicted example, computer system 106 includes identity authority 116 that includes list of websites 118. Identity authority 116 may be a server or a combination of hardware and software capable of storing list of websites 118 and communicating with other computer systems. List of websites 118 may include one or more websites. Moreover, list of websites 118 may include one or more websites in which a user uses or maintains a website user identity and a password, such as website user identity 112 and website password 114. Thus, user may initially enter one or more websites to create list of websites 118, and user may modify list of websites 118 by adding or removing websites. Each website in list of websites 118 may be a uniform resource locator, organization name, number, or any other data that can be used to identify or specify a particular website, such as website 110.

In the depicted example, computer system 108 includes password vault 120 with policy 122, passwords 124, and set of passwords 126. In these illustrative examples, when “set” is used with reference to items “set” means one or more items. For example, set of passwords 126 means one or more passwords. Set of passwords 126 is a subset of passwords 124. As used herein, “subset” means one or more items of a set of items. For example, set of passwords 124 may be one or more passwords of passwords 124. Set of passwords 126 may be selected from passwords 124 based upon the set of passwords meeting policy 122. Policy 122 may be a set of rules, which consists of one or more rules associated with set of passwords 124. For example, a rule may determine when set of passwords 124 is selected or when set of passwords 124 is changed. After set of passwords 124 is changed, password vault 120 may then update a set of websites with set of passwords 124.

In some illustrative examples, identity authority 116 may send a request to password vault 120 to update set of passwords 126 independent of any notifications from website 110. For example, identity authority 116 may determine that after a certain amount of time has elapsed, set of passwords 126 need to be changed. Furthermore, identity authority 116 may send a request to password vault 120 to update a corresponding set of websites with set of passwords 126.

Furthermore, in the depicted example, notification 128 is sent from website 110 to network 102. Notification 128 may be sent due to website password 114 expiring or being compromised. For example, after a certain period of time has elapsed since website password 114 was last changed or created, notification 128 will be sent indicating that website password 114 has expired. Moreover, website password 114 may be compromised in many ways, such as, for example, a security breach of website 110, computer system 104, or any data associated with website user identity 112 and website password 114.

Furthermore, in the depicted example, network 102 sends notification 130 to identity authority 116. Notification 130 may be the same as notification 128 or may be modified by network 102. Notification 130 indicates to identity authority 116 that website password 114 needs to be changed. For example, notification 130 may indicate that website password 114 for website 110 has expired, has been compromised, or needs to be changed. Identity authority 116 may then determine whether website 110 is in list of websites 118. If identity authority 116 determines that website 110 is in list of websites 118, then identity authority 116 sends notification 132 to network 102.

Network 102 sends notification 134 to password vault 120. Notification 134 may be the same as notification 132 or may be modified by network 102. Notification 134 indicates to password vault 120 that website password 114 needs to be changed. For example, notification 134 may indicate that website password 114 for website 110 has expired, has been compromised, or needs to be changed. Password vault 120 may then change set of passwords 124 according to policy 122. For example, policy 122 may include a rule that each password in set of passwords 124 that matches website password 114 must be changed. Another rule may specify that each password in set of passwords 124 that is within a threshold of similarity to website password 114 must be changed. Another rule may specify that only one password in set of passwords 124 must be changed if notification 134 indicates that website password 114 is expired. Another rule may specify that each password in set of passwords 124 that matches website password 114 must be changed if notification 134 indicates that website password 114 has been compromised.

In these illustrative examples, identifying a threshold of similarity between passwords may use pattern matching techniques to identify similarity between passwords. For example, a technique for identifying a similarity between passwords may be to identify passwords having one or more matching alphanumeric characters in the same relative position in the password. In this example, password “123mypass45” matches the first five alphanumeric characters of “123my54” and the last six alphanumeric characters of “321pass45”. Furthermore, the threshold for similarity may be the number of alphanumeric characters in the same relative position in the password not exceeding three alphanumeric characters. This example is not meant to imply physical or architectural limitations. Other patterns and other thresholds may be used. For, example, another pattern may look for matching alphanumeric characters regardless of position. In addition, instead of the threshold for similarity not exceeding three alphanumeric characters, the number of alphanumeric characters may be two, four, or any other user selected value.

In addition, determining that a website is in list of websites 118 may include identifying that a classification of the website matches one or more of a set of website classifications 136 that are selected or created by a user. A website classification may be a group, category, or type of website to which a website is associated or assigned.

In the depicted example, website 110, identity authority 116, and password vault 120 are located on different computer systems. However, in some embodiments, website 110, identity authority 116, and password vault 120 may be located on the same computer system, or distributed across two or more computer systems.

Program code located in network data processing system 100 may be stored on a computer recordable storage medium and downloaded to a data processing system or other device for use. For example, program code may be stored on a computer recordable storage medium on computer system 106 and downloaded to computer system 108 over network 102 for use on computer system 108. Furthermore, program code may be stored on a computer recordable storage medium on computer system 108 and downloaded to computer system 106 over network 102 for use on computer system 106.

In the depicted example, network data processing system 100 is a cluster of virtualizable systems. FIG. 1 is intended as an example, and not as an architectural limitation for the different illustrative embodiments.

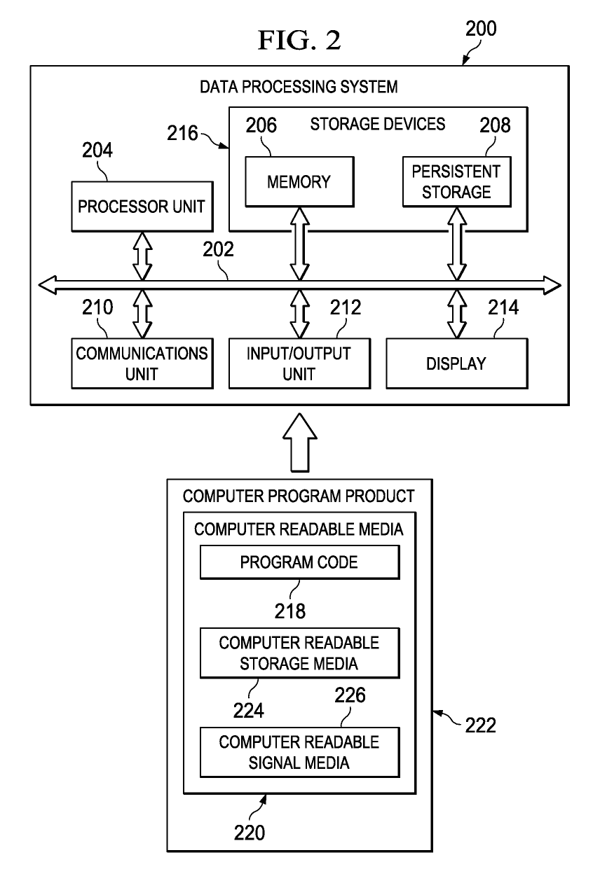

Turning now to FIG. 2, an illustration of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system 200 is an example of one implementation for computer systems 104, 106, 108 in network data processing system 100 in FIG. 1.

Processor unit 204 serves to run instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 or run by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 and run by processor unit 204. Program code 218 and computer readable media 220 form computer program product 222 in these examples. In one example, computer readable media 220 may be computer readable storage media 224 or computer readable signal media 226. Computer readable storage media 224 may include storage devices, such as, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage device, such as a hard drive, a thumb drive, or a flash memory, that is connected to data processing system 200. In some instances, computer readable storage media 224 may not be removable from data processing system 200. In these illustrative examples, computer readable storage media 224 is a non-transitory computer readable storage medium.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache, such as found in an interface and memory controller hub that may be present in communications fabric 202.

Thus, the different illustrative embodiments provide a method, data processing system, and computer program product for managing passwords. A computer system receives a notification from a website that indicates a password for the website needs to be changed. If the website is in a list of websites 118, then the computer system sends a notification to a password vault that indicates the password for the website needs to be changed. Password vault 120 selects set of passwords 126 based upon set of passwords 126 meeting policy 122.

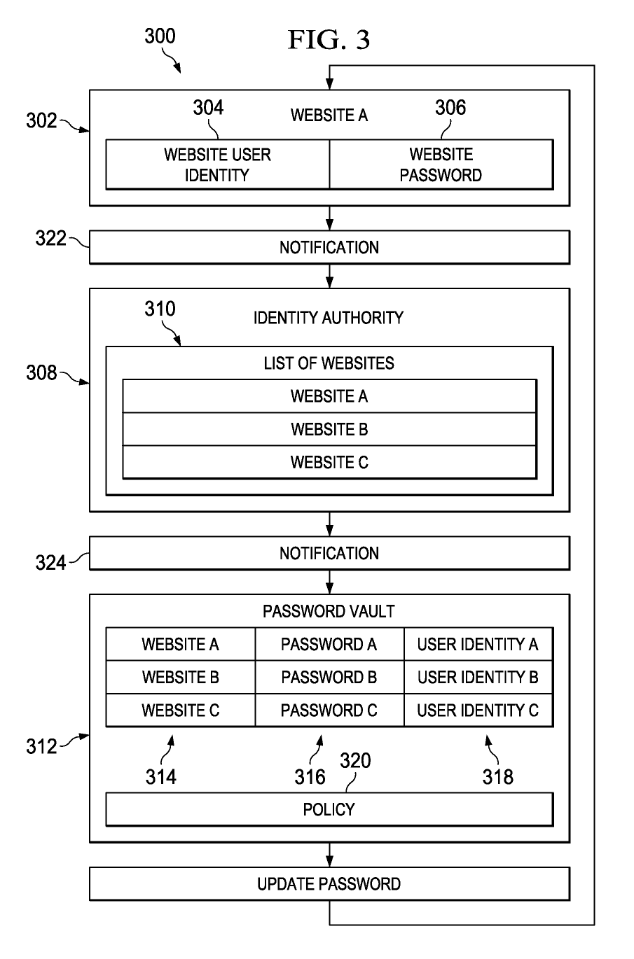

With reference now to FIG. 3, an illustration of a password management environment is depicted in accordance with an illustrative embodiment. Password management environment 300 may be implemented in network data processing system 100 in FIG. 1. In some illustrative examples, password management environment 300 may be implemented within a single computer, such as data processing system 200 in FIG. 2. In some illustrative examples, password management environment 300 may be implemented within a group of computers, such as data processing system 100 in FIG. 1.

In these illustrative examples, website A 302 includes website user identity 304 and corresponding website password 306, such as, for example, website user identity 112 and website password 114 in FIG. 1. Identity authority 308 contains list of websites 310. Furthermore, password vault 312 contains password-related information including website A 314, password A 316, and user identity A 318. Password vault 312 also contains policy 320, which is a set of rules that are associated with set of passwords 124, as described below. For example, policy 320 may determine when password A 316 is changed to a new password.

In these illustrative examples, website A 302 sends notification 322 indicating that website password 306 is expired. Website A 302 may be registered with identity authority 308. For example, a user may register website A 302 with identity authority 308. Furthermore, identity authority 308 may be registered with password vault 312. Thus, notification 322 may be sent to identity authority 308 to indicate that website password 306 needs to be changed.

Notification 322 may be in the form of computer-readable program code or may be in the form of human readable words or codes. For example, if notification 322 is in human readable words, then identity authority 308 may convert notification 322 into computer-readable program code or may parse notification 322. Furthermore, additional notifications may be simultaneously sent to one or more additional locations. For example, an additional notification may be sent to a user.

Identity authority 308 determines that website A 302 is in list of websites 310. For example, if website A 302 is registered with identity authority 308, then website A 302 is in list of websites 310. However, in some illustrative embodiments, other criteria must be met in order for website A 302 to be in list of websites 310, such as being selected by a user to be included in list of websites 310.

Identity authority 308 then sends notification 324 to password vault 312 indicating that password A 306 is expired. Password vault 312 implements a set of rules defined by policy 320. In these illustrative examples, the set of rules specify that when password A 306 expires, password A 316 is changed to a new password and the new password is sent to website A 302 to update website password 306 to the new password. The new password may be sent along a same or similar path as notification 322 and notification 324 or via another path.

The illustration of password management environment 300 in FIG. 3 is not meant to imply physical or architectural limitations to the manner in which different illustrative embodiments may be implemented. Other policies or combinations of policies may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

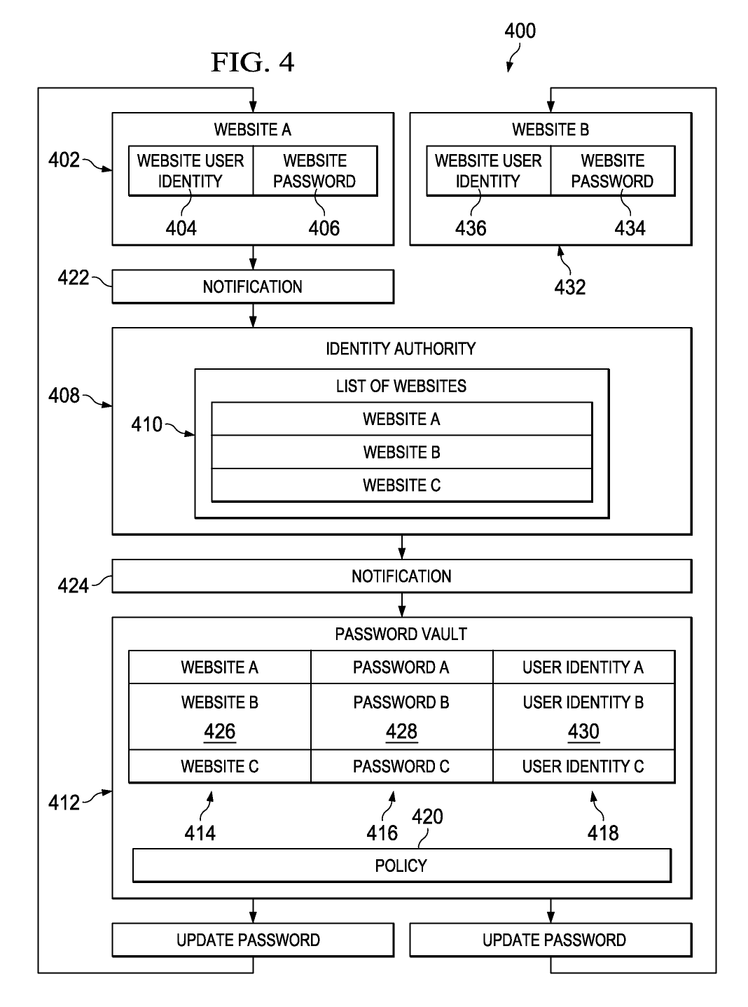

With reference now to FIG. 4, an illustration of a password management environment is depicted in accordance with an illustrative embodiment. Password management environment 400 may be implemented in network data processing system 100 in FIG. 1. In some illustrative examples, password management environment 400 may be implemented within a single computer, such as data processing system 200 in FIG. 2. In some illustrative examples, password management environment 400 may be implemented within a group of computers, such as data processing system 100 in FIG. 1.

In these illustrative examples, website A 402 includes website user identity 404 and corresponding website password 406. Identity authority 408 contains list of websites 410. Furthermore, password vault 412 contains password-related information including website A 414, password A 416, and user identity A 418. Password vault 412 also contains policy 420. In this illustrative example, website A 402 sends notification 422 indicating that website password 406 has been compromised. Identity authority 408 determines that website A 402 is in list of websites 410. Identity authority 408 then sends notification 424 to password vault 412 indicating that website password 406 has been compromised.

Password vault 412 implements a set of rules defined by policy 420. In these illustrative examples, the set of rules specify that when website password 406 is compromised, password A 416 is changed to a new password and any other passwords in password vault 412 that are the same as password A 416 are also changed to the new password. In this illustrative example, password vault 412 also contains password-related information for website B 426, matching password B 428, and user identity B 430. Because password B 428 is the same as password A 416, password B is also changed to the new password. In this illustrative example, the rule then causes password A 416 to be sent to website A 402 to update website password 406 and causes password B 428 to be sent to website B 432 to update website password 434 which is associated with website user identity 436.

In some illustrative examples, password vault 412 may maintain a list or a table of matching passwords that is searched to find matching passwords. In other illustrative examples, password vault 412 may maintain a list of passwords that need to be kept in synchronization with each other. In other illustrative examples, password vault 412 may additionally update passwords that are within a threshold of similarity to password A 416, as described for FIG. 1 above.

The illustration of password management environment 400 in FIG. 4 is not meant to imply physical or architectural limitations to the manner in which different illustrative embodiments may be implemented. Other policies or combinations of policies may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, another policy or set of rules may specify that when a particular password in password vault 412 is changed to a new password because it has expired, then all other passwords that match the particular password are also changed to the new password. The policy may then update all of the corresponding websites with the new passwords. The policy may also update all other passwords that are within a threshold of similarity to the expired password. The threshold of similarity may be defined in many ways, some of which are described for FIG. 1 above.

Another policy may specify that when a particular password in password vault 412 is changed to a new password because it has been compromised, then all other passwords that match the particular password and that are within a threshold of similarity to the expired password are also changed to the new password. The policy may then update all of the corresponding websites with the new passwords. The policy may also update all other passwords that are within a threshold of similarity to the expired password.

Another policy may specify that when a particular password in password vault 412 is changed to a new password because the password has been compromised, then all other passwords that match the particular password and that are within a threshold of similarity to the expired password are also changed to a new password, wherein all of the new passwords are different from each other. The policy may then update all of the corresponding websites with the new passwords. The policy may similarly update all other passwords that are within a threshold of similarity to the expired password.

Furthermore, another policy or set of rules may select set of passwords 126 based upon a classification of website 110 associated with each password. For example, a website may be classified by associating the website with one or more categories and one or more levels of security that are selected or created by a user. The set of rules may select set of passwords 126 based on passwords that are associated with a particular category of website or that belong in a specified group of websites. The category or group may be selected by a user. Categories may include financial, gaming, entertainment, work-related, social networking, and any other suitable categories for identifying websites.

Furthermore, another policy or set of rules may select set of passwords 126 based upon a level of security assigned to website password 114. For example, the set of rules may select set of passwords 126 based on passwords that are associated with a particular level of security, such as high, medium, or low. Of course other numbers of levels of security may be present and other types of labels may be used to indicate the levels of security. For example, six levels of security may be present and each level may be designated with an integer.

Another set of rules may select set of passwords 126 based upon a new level of security required for website password 114 by website 110. In some illustrative examples, website 110 may change password requirements by requiring passwords to include one or more additional characters, types of characters, or expiring passwords sooner. For example, website 110 may change password requirements from an original requirement of six or more alphanumeric characters to a new requirement specifying eight or more alphanumeric characters that include at least one number and at least one special character. Thus, password vault 120 may select set of passwords 126 based on the new requirement.

Another set of rules may select set of passwords 126 based upon an access to website 110 from an unauthorized internet protocol address. For example, website 110 may track internet protocol addresses that are used for logging into website 110. If an unauthorized internet protocol address is used for logging into website 110, website 110 may send notification 128 to identity authority 116 to indicate that the unauthorized internet protocol address was used. Identity authority 116, in turn, may then send notification 132 to password vault 120 indicating that the unauthorized internet protocol address was used.

The level of security may be selected by a user. Furthermore, a set of rules may select passwords 126 based upon a classification of website 110 associated with set of passwords 126 and a level of security associated with set of passwords 126. For example, when a high-security password for a banking website is compromised, a set of rules may select all passwords in passwords 124 that are high-security passwords and that are used for banking websites.

Moreover, sending notifications and sending new passwords to websites may all occur without any user input. Furthermore, instead of website A 402 sending notifications regarding expired passwords, identity authority 408 or password vault 412 may generate notification 424 upon determining that a password has expired after a period of time has elapsed. Thus, in some illustrative examples, identity authority 408 or password vault 412 may contain policies that expire passwords after a certain amount of time has passed since the passwords are created or are changed.

In addition, password vault 412 may exist on multiple devices or computers and thus have the ability to synchronize between the devices or computers. Furthermore, identity authority 408 may implement a policy or set of rules to determine list of websites 118. For example, a set of rules at identity authority 408 may select websites of a particular category in order to create list of websites 118. Categories may include financial, gaming, entertainment, work-related, social networking, and any other suitable categories for identifying websites. Alternatively, list of websites 118 may be specified by a user.

Moreover, determining that a website is in list of websites 118 may include identifying that a classification of the website matches one or more of a set of website classifications 136. A website classification may be a group, category, or type of website to which a website is associated or assigned. For example, set of website classifications 136 may include website categories and levels of security, as described above.

Thus, for example, determining that a website is in list of websites 118 may include identifying that the website is a financial website because the website matches the “financial” classification. This may be useful, for example, for implementing a policy that updates passwords for all websites classified as “financial” whenever a password for a particular “financial” website becomes compromised or expired. As another example, identity authority 408 may determine that a website is in list of websites 118 only if it matches a particular set of website classifications 136, such as “financial.” Thus, only “financial” websites would be included in list of websites 118. In some illustrative examples, there may be a set of additional identity authorities that may be used to identify websites of different website classifications 136 or combinations of website classifications 136.

Moreover, the website may also match additional classifications. For example, if the website is related to a retirement plan, then the website may also match a “work-related” or “personal” classification. In some illustrative examples, identity authority 408 may send set of website classifications 136 to password vault 412 for use in selecting set of passwords 126 based on policy 122.

Another policy may be used for identifying password vaults for list of websites 118. In some illustrative examples, different password vaults may be used for different websites or different classifications of websites. Furthermore, notification 134 may include a set of information required for the identified password vault, wherein the set of information includes the one or more website classifications 136.

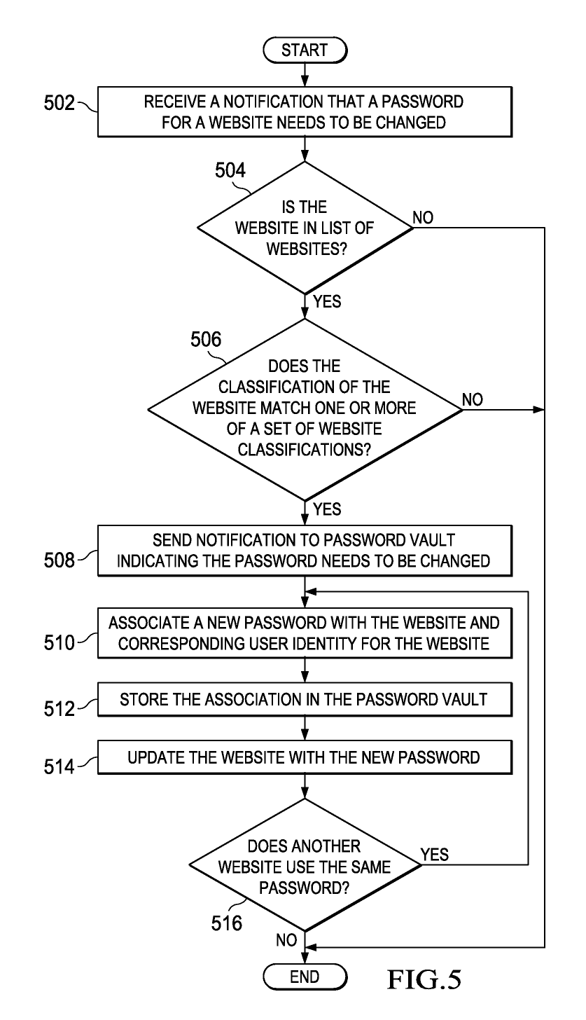

With reference now to FIG. 5, an illustration of a flowchart of a process for managing passwords is depicted in accordance with an illustrative embodiment. The process illustrated in FIG. 5 may be implemented in a password management environment, such as password management environment 300 in FIG. 3.

The process begins by receiving a notification that a password for a website needs to be changed (step 502). The process then determines whether the website is in list of websites 118 (step 504). If the website is not in list of websites 118, then the process terminates. If the website is in list of websites 118, then the process determines if the classification of the website matches one or more of a set of website classifications 136 (step 506). If the classification of the website does not match one or more of the set of website classifications 136, then the process terminates.

If the classification of the website does match one or more of the set of website classifications 136, the process sends a notification to password vault 120 indicating the password needs to be changed (step 508). The process then associates a new password with the website and corresponding user identity for the website (step 510). The process then stores the association in password vault 120 (step 512). Next, the process updates the website with the new password (step 514). The process then determines whether another website uses the same password (step 516). If another website does not use the same password, the process terminates. If another website does use the same password, then the process returns to step 510. In some illustrative embodiments, one or more of the above steps may be omitted.

In some illustrative embodiments, if identity authority 116 receives a notification from a website, but the website is not in list of websites 118, then identity authority 116 will not send any notifications to password vault 120. Thus, no action will be taken to change any passwords. Moreover, in some illustrative embodiments, if identity authority 116 receives a notification from a website, and the website is in list of websites 118 but the website does not belong to any website classification defined in website classifications 136, then identity authority 116 will not send any notifications to password vault 120. Therefore, identity authority 116 may function as a filter that only notifies password vault 120 regarding certain websites.

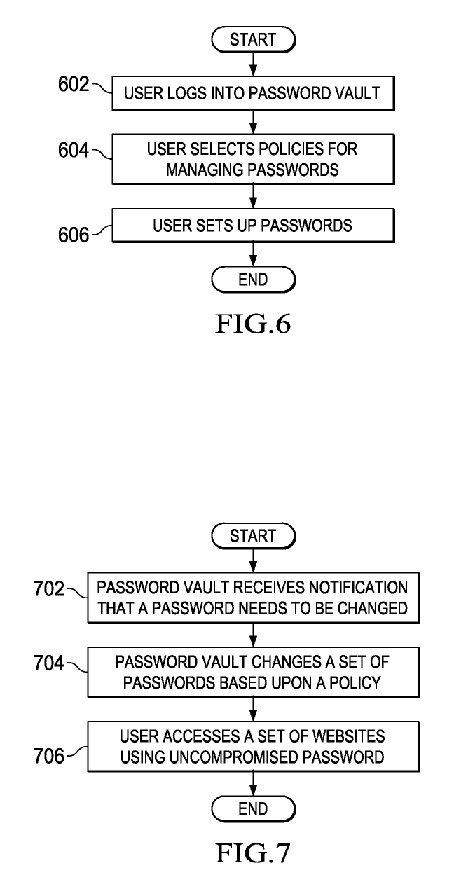

With reference now to FIG. 6, an illustration of a flowchart of a process for managing passwords is depicted in accordance with an illustrative embodiment. The process illustrated in FIG. 6 may be implemented in a password management environment, such as password management environment 300 in FIG. 3.

The process begins when a user logs into a password vault (step 602). For example, the user may use a master password to access the password vault. The user then selects policies for managing passwords (step 604). The policies may be a set of rules for managing passwords. In some illustrative examples, the user may create policies or import policies from another source such as websites or databases. The user then sets up passwords in password vault 412 (step 606). In some illustrative examples, the user may enter initial passwords and enter additional passwords to create a queue of passwords that can be used to create new passwords when old passwords need to be changed. In other embodiments, the passwords are generated by an algorithm. In some illustrative examples, the user may select one or more algorithms for generating initial passwords or generating new passwords. Thereafter, the process terminates.

With reference now to FIG. 7, an illustration of a flowchart of a process for managing passwords is depicted in accordance with an illustrative embodiment. The process illustrated in FIG. 7 may be implemented in a password management environment, such as password management environment 300 in FIG. 3.

The process begins when a password vault receives a notification that a password needs to be changed (step 702). The password vault then changes a set of passwords based upon a policy (step 704). The policy may be a set of rules for managing the set of passwords. A user then accesses a set of websites using uncompromised passwords (step 707). In some embodiments, the password vault may log the user into the websites with the new passwords. In other embodiments, the user may manually enter the new passwords to log into the websites. Thereafter, the process terminates.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the invention is a method, data processing system, and computer program product for managing passwords. A computer system receives a notification from a website that indicates a password for the website needs to be changed. The computer system sends a notification to a password vault that indicates the password for the website needs to be changed. A set of passwords in the password vault is selected based upon the set of passwords meeting a policy.

The invention provides advantages over current processes for managing passwords. For example, current processes include a lag between compromise of a password and updating of the password and any other passwords by a user. Thus, a user is exposed to a higher degree of risk when a password is compromised. A more convenient and faster process of updating multiple passwords may be desired because fewer errors may be made and a user is exposed to less risk as a result of password compromise.

For example, a list of websites may keep track of websites that a user maintains a user identity and corresponding password. If a password for a particular website is compromised or expired, the password may be updated by a password vault, along with a set of additional passwords that are the same or similar. Thus, multiple websites can be updated with a new password to provide greater security in the event that a password for a particular website has been compromised or is expired.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing passwords, the method comprising:
receiving, at a computer system, a notification from a website, wherein the notification from the website indicates that a password of a user for the website needs to be changed; and
responsive to determining by the computer system that the website is in a list of websites and a classification of the website matches one or more of a set of website classifications, sending, from the computer system, a notification to a password vault for selecting a set of passwords stored in the password vault based upon the set of passwords meeting a policy, wherein the notification to the password vault indicates that the password needs to be changed and the policy is for password management.

2. The method of claim 1 wherein the set of website classifications comprises website categories and levels of security, and wherein the list of websites is selected by the user.

3. The method of claim 1, wherein the classification of the website matching the set of website classifications comprises the website matching one or more website categories and a level of security.

4. The method of claim 1, wherein the policy is a first policy and the password vault is identified using a second policy for identifying password vaults for the list of websites.

5. The method of claim 1 further comprising:
receiving, by the password vault, the notification indicating the password needs to be changed;
selecting, by the password vault, the set of passwords stored in the password vault based upon the set of passwords meeting the policy, wherein the policy is for selecting passwords that are the same as the password needing to be changed;
changing, by the password vault, each password in the set of passwords; and
updating, by the password vault, a corresponding set of websites with the set of passwords selected.

6. The method of claim 5, wherein the changing occurs without user input.

7. The method of claim 1, wherein the notification from the website further indicates that the password for the website has been compromised and wherein the notification to the password vault further indicates that the password for the website has been compromised.

8. The method of claim 1 further comprising:
associating, by the password vault, a new password with the website and corresponding user identity for the website;
storing, by the password vault, the association in the password vault;
updating, by the password vault, the website with the new password;
determining, by the password vault, whether a set of additional websites use a same password as the password for the website;
responsive to a determination that the set of websites use the same password, associating, by the password vault, the new password with the set of additional websites and a set of corresponding user identities for the set of additional websites to form a set of associations;
storing, by the password vault, the set of associations in the password vault; and
updating, by the password vault, the set of additional websites with the new password.

9. The method of claim 1, further comprising:
responsive to determining that a period of time has passed since the password was last updated, sending, from the computer system, the notification to the password vault for selecting the set of passwords stored in the password vault based upon the set of passwords meeting the policy, wherein the notification to the password vault indicates that the password needs to be changed.

10. A data processing computer system comprising:
a bus;
a communications unit connected to the bus;
a storage device connected to the bus, wherein the storage device stores program code; and
a processor unit connected to the bus, wherein the processor unit is configured to run the program code to receive, at a computer system, a notification from a website, wherein the notification from the website indicates that a password of a user for the website needs to be changed; and send, from the computer system, a notification to a password vault for selecting a set of passwords stored in the password vault based upon the set of passwords meeting a policy in response to determining by the computer system that the website is in a list of websites and a classification of the website matches one or more of a set of website classifications, wherein the notification to the password vault indicates that the password needs to be changed and the policy is for password management.

11. The data processing computer system of claim 10, wherein the set of website classifications comprises website categories and levels of security, and wherein the list of websites is selected by the user.

12. The data processing computer system of claim 10, wherein in being configured to run the program code to determine that the classification of the website matches one or more of the set of website classifications, the processor unit is configured to run the program code to determine that the classification of the website matches one or more website categories and a level of security.

13. The data processing computer system of claim 10, wherein the processor unit is configured to run the program code to change each password in the set of passwords and update a corresponding set of websites with the set of passwords in response to selecting the set of passwords.

14. The data processing computer system of claim 10, wherein in being configured to run the program code to receive the notification from the website, the processor unit is configured to run the program code to indicate that the password for the website has been compromised and wherein in being configured to run the program code to send the notification to the password vault, the processor unit is configured to run the program code to indicate that the password for the website has been compromised.

15. The data processing computer system of claim 10, wherein the password vault associates a new password with the website and corresponding user identity for the website, stores the association in the password vault, updates the website with the new password, determines whether a set of additional websites use a same password as the password for the website, associates the new password with the set of additional websites and a set of corresponding user identities for the set of additional websites to form a set of associations in response to a determination that the set of websites use the same password, stores the set of associations in the password vault, and updates the set of additional websites with the new password.

16. A computer program product for managing passwords comprising:
a computer readable storage device;
program code, stored on the computer readable storage device, for receiving, at a computer system, a notification from a website, wherein the notification from the website indicates that a password of a user for the website needs to be changed;
program code, stored on the computer readable storage device, for sending, from the computer system, a notification to a password vault for selecting a set of passwords stored in the password vault based upon the set of passwords meeting a policy in response to determining by the computer system that the website is in a list of websites and a classification of the website matches one or more of a set of website classifications, wherein the notification to the password vault indicates that the password needs to be changed and the policy is for password management.

17. The computer program product of claim 16, wherein the set of website classifications comprises website categories and levels of security, and wherein the list of websites is selected by the user.

18. The computer program product of claim 16, wherein the program code for determining that the classification of the website matches one or more of the set of website classifications comprises program code for determining that the classification of the website matches one or more website categories and a level of security.

19. The computer program product of claim 16, wherein the program code for receiving the notification from the website comprises program code for indicating that the password for the website has been compromised and wherein the program code for sending the notification to the password vault comprises program code for indicating that the password for the website has been compromised.

20. The computer program product of claim 16, wherein the password vault associates a new password with the website and corresponding user identity for the website, stores the association in the password vault, updates the website with the new password, determines whether a set of additional websites use a same password as the password for the website, associates the new password with the set of additional websites and a set of corresponding user identities for the set of additional websites to form a set of associations in response to a determination that the set of websites use the same password, stores the set of associations in the password vault, and updates the set of additional websites with the new password.
